(19) United States
(12) Patent Application Publication
(10) Pub. No.: US 2009/0007461 A1
(43) Pub. Date: Jan. 8, 2009

(54) TRACKED VEHICLE

(75) Inventors: Michel Pelletier, Canton de Shefford (CA); Martin Runggaldier, St. Christina (IT)

Correspondence Address: BELL, BOYD & LLOYD, LLP, P.O. Box 1135, CHICAGO, IL, 60690, US

(73) Assignee: Rolic Invest Sarl, Luxembourg (LU)

(21) Appl. No.: 11/868,327

(22) Filed: Oct. 5, 2007

(30) Foreign Application Priority Data
Oct. 6, 2006 (EP) 06020981.4

(51) Int. Cl. E01H 4/02; B62D 55/06; E01H 5/00

(52) U.S. Cl. 37/219; 180/9.1; 180/9.62

(57) ABSTRACT

A tracked vehicle, particularly a piste grooming vehicle including a transmission powered chassis comprising a plurality of axled gear wheels for a track, the chassis comprising a maximum track width and a traction length between the frontmost and rearmost axle of the gear wheels, is characterized in that the control ratio, as the result of dividing the traction length by the track width, is smaller or equal to 1.5 preferably smaller or equal to 1.4 and that the transmission has a power of at least 400 HP.

### PRIORITY CLAIM

This application is a continuation of, claims the benefit of, and priority to European Patent Application No. 06020981.4, filed Oct. 6, 2006, the entire contents of which are incorporated herein by reference.

The present invention relates to a tracked vehicle, and particularly a piste grooming vehicle, including a transmission powered chassis comprising a plurality of axled gear wheels for a track, the chassis having a maximum track width (W) and a traction length (L) between the frontmost and rearmost axle of the gear wheels.

### BACKGROUND

The configuration of the chassis of a piste grooming vehicle (sometimes referred to as a snow cat) is of substantial relevance since this contributes towards deciding how suitable the vehicle is for the particular terrain. In recent years, in striving to achieve optimized footprint performance and enhanced time savings, snow cat construction has been based on configuring tracks, fixed and rotary ploughs as wide as possible with high power transmission. These configuration run counter, however, to maneuverability. In other words, such prior art wide tracks perform unsatisfactorily, particularly in soft snow.

### SUMMARY

One advantage of the present disclosure is thus to provide a generic tracked vehicle featuring good maneuverability combined simultaneously with high power.

This is achieved in a preferred embodiment of the disclosure in that the control ratio, as the result of dividing the traction length by the track width, is smaller or equal to 1.5, preferably smaller or equal to 1.4, and that the transmission has a power of at least 400 HP.

The control ratio S represents the maneuverability of the vehicle where:

$$control ratio S = \frac{traction length L}{track width W}$$

The traction length L is the distance between the frontmost axle and the rearmost axle of the vehicle, mounting the sprockets and/or idlers for the track. The traction length L thus substantially corresponds to the length of the footprint of the vehicle (traction length L and track width W are to be cited in the same dimensions, preferably in meters).

The track width W is the distance between the right-hand and left-hand gear wheel on a common axle on opposite sides of the vehicle.

The smaller the control ratio S, the better the maneuverability of the vehicle. The higher this value, the higher the climbing ability of the vehicle which, however, decreases the degree of maneuverability.

Tests carried out by the applicant show that a control ratio S of a magnitude of the order of 1.4 is the best compromise between maneuverability and climbing ability.

In accordance with a preferred embodiment of the disclosure, the transmission has a power of at least 450 HP preferably at least 500 HP. It is most favorable that the transmission has a power exceeding 500 HP. Combining these power indications with the control ratio S as defined in the scope of the disclosure provides an optimum combination of maneuverability, thrust and climbing ability.

Additional features and advantages are described herein, and will be apparent from, the following Detailed Description and the figures.

### BRIEF DESCRIPTION OF THE FIGURES

The further details of the disclosure will now be detailed with reference to the drawing in which

FIG. 1 is a front view of one embodiment of the piste grooming vehicle, and

FIG. 2 is a side view of the piste grooming vehicle shown in FIG. 1.

### DETAILED DESCRIPTION

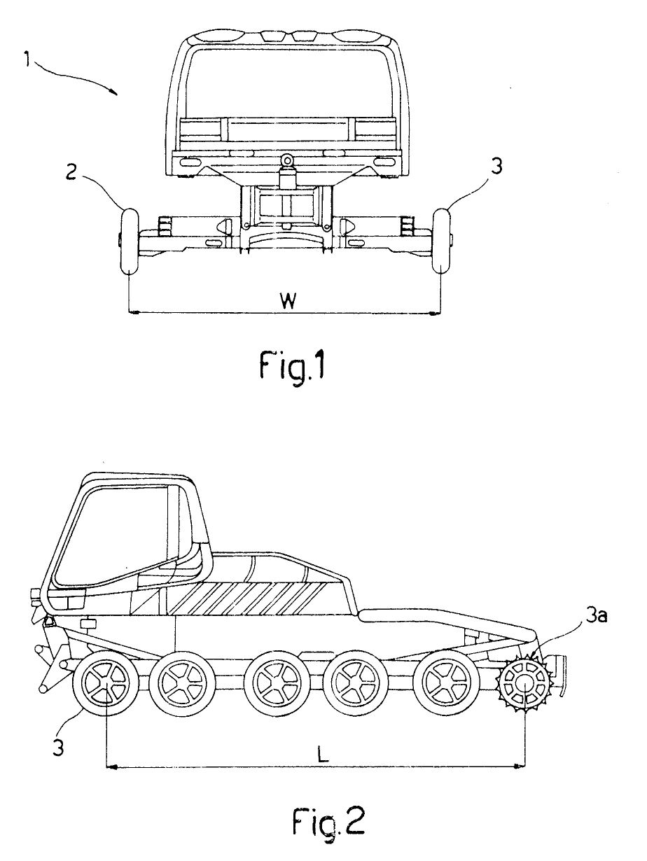

Referring now to FIG. 1, there is illustrated a front view of a piste grooming vehicle 1 comprising a plurality of idlers and/or sprockets 2 and 3 for a track (not shown). The track width W is the axle distance between the left-hand idler (or sprocket) 2 and the right-hand idler (or sprocket) 3.

Referring now to FIG. 2, there is illustrated a side view of the piste grooming vehicle 1 showing that the traction length L is the distance between the frontmost axle and rearmost axle of the idlers and/or sprockets 3 and 3a. The traction length L in this arrangement relates to the distance between the corresponding axes of rotation of the idlers and/or sprockets 3 and 3a. In accordance with this aspect of the present disclosure, it is provided for that the control ratio S as the result of dividing the traction length L by the track width W is smaller than or equal to 1.5—preferably smaller than or equal to 1.4—and that the transmission has a power of at least 400 HP, but preferably of more than 500 HP.

In this arrangement, it may be expedient when the track width is in the range of preferably 2.8 m to 3.3 m, preferably approximately 3 m and the traction length is in the range 3.9 m to 4.4 m, preferably approximately 4.2 m.

The present invention is not restricted to the example aspect as shown, it instead covering all and any technical variants and technical equivalents within the scope as claimed.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A tracked vehicle comprising:
a transmission powered chassis having a plurality of axled gear wheels for a track, the chassis having a maximum track width (W) and a traction length (L) between a frontmost axle and a rearmost axle of gear wheels, characterized in that the control ratio (S), as the result of dividing the traction length (L) by the track width (W), is smaller or equal to 1.5; and
a transmission coupled to the chassis having a power of at least 400 HP.

2. The tracked vehicle of claim 1, which is a piste grooming.

3. The tracked vehicle of claim 1, wherein the control ratio is smaller or equal to 1.4.

4. The tracked vehicle of claim 1, wherein the transmission has the power of at least 450 HP.

5. The tracked vehicle of claim 1, wherein the transmission has the power of at least 500 HP.

6. The tracked vehicle of claim 1, wherein the transmission has the power exceeding 500 HP.

7. The tracked vehicle of claim 1, wherein the track width (W) is in the range of preferably 2.8 m to 3.3 m.

8. The tracked vehicle of claim 1, wherein the track width (W) is approximately 3 m.

9. The tracked vehicle of claim 1, wherein the traction length (L) is in the range 3.9 m to 4.4 m.

10. The tracked vehicle of claim 1, wherein the traction length (L) is approximately 4.2 m.

11. The tracked vehicle of claim 1, wherein the gear wheels are configured as sprockets or idlers for the track.
